(19) United States
(12) Patent Application Publication
(10) Pub. No.: US 2018/0164453 A1
(43) Pub. Date: Jun. 14, 2018

(54) Method for Improved Geophysical Investigation

(71) Applicant: Sub Salt Solutions Limited, London (GB)

(72) Inventors: Ernie ESSER, London (GB); Liuis GUASCH, London (GB)

(21) Appl. No.: 15/577,647

(22) PCT Filed: May 27, 2016
(86) PCT No.: PCT/EP2016/062091

§ 371 Date: Nov. 28, 2017

(30) Foreign Application Priority Data
May 29, 2015 (GB) 1509337.0

(51) Int. Cl. G01V 1/28

(52) U.S. Cl. CPC G01V 1/282; G01V 2210/614

(57) ABSTRACT

There is provided a method of subsurface exploration, the method comprising generating a geophysical representation of a portion of the volume of the Earth from measurements of at least one observable physical quantity. The method involves providing an observed geophysical data set derived from measurements of at least one observable physical quantity relating to the portion of the volume of the Earth and generating a predicted geophysical data set using a subsurface model of the portion of the Earth. The subsurface model has a spatial geometry and comprises a plurality of model coefficients representing at least one geophysical parameter. One or more objective functions are provided which are operable to measure the similarity and/or dis-similarity between the observed and predicted geophysical datasets. Then, the subsurface model is iteratively modified to minimise and/or maximise the one or more objective functions. The or each iterative step modifies a subsurface model to produce an updated subsurface model and one or more iterative steps comprises: defining one or more directed paths through a subsurface model, the or each directed path being defined with respect to the spatial geometry of the subsurface model; defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and; updating the subsurface model utilising the asymmetric controls. An updated sub-surface model of a portion of the Earth for subsurface exploration is then provided.

### CROSS REFERENCE TO RELATED APPLICATIONS

This application is the U.S. National Stage entry under 35 U.S.C. § 371 of International Patent Application No. PCT/EP2016/062091, filed May 27, 2016, and entitled “Method for Improved Geophysical Investigation,” which claims priority to GB Application No. 1509337.0 filed May 29, 2015 and entitled “Method for Improved Geophysical Investigation,” both of which are incorporated by reference herein in their entireties for all purposes.

### STATEMENT REGARDING FEDERALLY SPONSORED RESEARCH OR DEVELOPMENT

Not applicable.

### BACKGROUND

The present invention relates to a method of, and apparatus for, improved geophysical investigation. More particularly, the present invention relates to an improved method of, and apparatus for, inversion modelling in which asymmetric constraints and/or penalties can be implemented to improve convergence and model accuracy, mitigating the non-uniqueness of the inverse problem by restricting its possible solutions.

There is significant interest in surveying sections of the Earth to detect natural mineral resources or other sites of geological interest. Several methods of surveying are used to fulfil this purpose, each focusing on the response of the earth to different stimuli in different contexts. For example but not limited to: seismic, electro-magnetic, electric or gravity.

### SUMMARY OF THE DISCLOSURE

The present invention can be applied to any of the above-mentioned exploration methods. In fact, all of them can be posed as an inverse problem where pertinent data is acquired in the field; then a mathematical solution is used to represent the Earth's subsurface behaviour to generate data that mimics the acquired data. Whilst following description focuses on seismic data, the skilled person would be aware that the method of the present invention could be readily applied to any of the other exploration methods.

Seismic surveys are the principal means by which the petroleum industry can explore the subsurface of the Earth for oil and gas reserves. Typically, seismic survey data is acquired and analysed with regard to identifying locations suitable for direct investigation of the sub-surface by drilling. Seismic surveying also has applications within the mining industry and within other industrial sectors that have an interest in details of the subsurface of the Earth.

In a seismic survey, one or more natural or artificial seismic sources are arranged to generate vibrational energy which is directed into the subsurface of the Earth. Reflected, refracted and other signals returned from subsurface features are then detected and analysed. These signals can be used to map the subsurface of the Earth.

A schematic illustration of an experimental set up 10 for an undersea seismic survey is shown in FIG. 1. However, this example is intended to be non-limiting and an equivalent experiment can be carried out on land. The present invention is applicable to subsurface exploration in any suitable environment, for example land or marine measurements of a portion of the subsurface of the Earth. The present invention may be applicable to identification of numerous subsurface resources, and is intended to include oil exploration and gas prospecting.

The skilled person would be readily aware of the suitable environments in which data could be gathered for analysis and exploration purposes as set out in the present disclosure.

In this example, the experimental set up 10 comprises a source 12. In this example, the source 12 is located on a ship 14, although this need not be the case and the source may be located on land, or within the sub-surface, or on any other suitable vessel or vehicle.

The source 12 generates acoustic and/or elastic waves having sufficient vibrational energy to penetrate the subsurface of the Earth and generate sufficient return signals to aid useful detection. The source 12 may comprise, for example, an explosive device, or alternatively an air gun or other mechanical device capable of creating sufficient vibrational disturbance. Commonly, for many seismic survey experiments a single source is used which is shot from multiple locations. Multiple simultaneous sources as well as naturally occurring sources may also be employed.

A plurality of detectors 16 is provided. The detectors 16 may comprise any suitable vibrational detection apparatus. Commonly, two types of device are used. Geophones which detect particle motion, and hydrophones which detect pressure variations. Commonly, a large number of detectors 16 are laid out in lines for 2D data acquisition. Alternatively, the detectors 16 can be arranged in sets of lines or in a grid for 3D data acquisition. Detectors 16 may also be located within the subsurface, for example down boreholes. The detectors 16 are connected to trace acquisition apparatus such as a computer or other electronic storage device. In this example, the acquisition apparatus is located on a further ship 18. However, this need not be the case and other arrangements are possible.

In use, elastic waves 20 generated by the source 12 propagate into the subsurface 22 of the Earth. The subsurface 22, in general, comprises one or more layers or strata 24, 26, 28 formed from rock or other materials. The elastic waves 20 are transmitted and refracted through the layers and/or reflected off the interfaces between them and/or scattered from other heterogeneities in the sub-surface and a plurality of return signals 30 is detected by the detectors 16.

In general, the returning signals 30 comprise elastic waves having different polarisations. Primary or pressure waves (known as P-waves) are approximately longitudinally polarised and comprise alternating rarefactions and compressions in the medium in which the wave is travelling. In other words, in an isotropic environment, the oscillations of a P-wave are parallel to the direction of propagation. P-waves typically have the highest velocity and so are typically the first to be recorded. P-waves travel at a velocity Vₚ in a particular medium. Vₚ may vary with position, with direction of travel, with frequency, and with other parameters, and is, effectively, the speed of sound in a medium. It is this quantity Vₚ which is most commonly of particular interest in seismic inversion.

Shear or secondary waves (known as S-waves) may also be generated. S-waves have an approximately transverse polarisation. In other words, in an isotropic environment, the polarisation is perpendicular to the direction of propagation. S-waves are in general, more slowly moving than P-waves in materials such as rock. Whilst S-wave analysis is possible and falls within the scope of the present invention, the following description will focus on the analysis of P-waves.

A seismic survey is typically composed of a large number of individual source excitation events. The Earth's response to these events is recorded at each receiver location, as a seismic trace for each source-receiver pair. For a two dimensional survey, the tens of thousands of individual traces may be taken. For the three dimensional case, this number may run into the millions.

A seismic trace comprises a sequence of measurements in time made by one or more of the multiplicity of detectors 16, of the returning reflected, refracted and/or scattered acoustic and/or elastic waves 30 originating from the source 12. In general, a partial reflection of the acoustic wave 20 occurs at a boundary or interface between two dissimilar materials, or when the elastic properties of a material changes. Traces are usually sampled in time at discrete intervals of the order of milliseconds.

Seismic surveys at the surface or seabed can be used to extract rock properties and construct reflectivity images of the subsurface. Such surveys can, with the correct interpretation, provide an accurate picture of the subsurface structure of the portion of the Earth being surveyed. This may include subsurface features associated with mineral resources such as hydrocarbons (for example, oil and natural gas). Features of interest in prospecting include: faults, folds, anticlines, unconformities, salt domes, reefs.

Key to this process of modelling and imaging a portion of earth is the seismic velocity Vₚ. In a portion of the volume of the Earth, Vₚ may be estimated in various ways. Different representations of Vₚ, such as slowness (1/Vₚ) or slowness squared may also be used.

It is known to solve such imaging problems using inverse problem approaches. In such approaches, models of physical properties such as Vₚ in a subsurface region are produced which have high fidelity and that are well resolved spatially (up to the theoretical limits of the method: travel-time tomography gives less resolved models for example, but they are still accurate).

Inverse problem approaches seek to extract the properties of subsurface rocks from a given seismic dataset recorded at the surface or seabed. A detailed velocity (or any other parameter inverted) is produced as a result, with typical resolution of the order of the seismic wavelengths used. The present invention produces results that can have even higher resolution because the final models are allowed to contain sharp discontinuities.

In an inverse problem approach, commonly a two or three dimensional model is generated to represent the measured portion of the Earth. The properties and parameters of the Earth model are then modified to generate predicted data that matches the experimentally obtained seismic trace data.

Inverse problem models can extract many physical properties (Vₚ and Vₛ velocities, attenuation, density, anisotropy) of the modelled portion of the Earth. However, Vₚ, the P-wave velocity, is a particularly important parameter which the subsequent construction of the other parameters depends heavily upon. Nevertheless, other parameters may be used with the present invention, either alone or in combination. The nature and number of parameters used in a model of a portion of the Earth will be readily apparent to the skilled person.

Inverse problem approaches seek to obtain an accurate and high resolution Vₚ model of the subsurface which generates predicted data that matches the recorded data. Predicted data is calculated using the full two-way wave equation. This is known as the forward problem. This equation can be in the time domain, the frequency domain, or other suitable domains, and it may be elastic or acoustic, isotropic or anisotropic, and may include other physical effects such as attenuation and dispersion. In most cases, the process proceeds using the acoustic approximation with a single component modelled wavefield, which in the marine case is pressure. The final model has potentially far higher resolution and accuracy however the method can fail due to the sensitivity of the predicted waveforms to the model.

Alternatively, the data may be a simplified subset of the recorded data and consequently the predicted data is computed using a simplified version of the wave equation. For example, in travel-time tomography, the observed data is analysed to extract arrival times of particular events. In this case the forward problem could be a solution to the eikonal equation.

An example of a basic starting model is shown in FIG. 2. The model shows a simple estimation of the subsurface of a portion of the Earth. The source of acoustic waves is shown as a star and a plurality of receivers shown as circles. Both the source and the receivers are located at or above the seabed. As shown, the basic model shows a gradually increasing Vₚ with increasing depth without any of the detailed structure present in a true earth model.

A modelled seismic gather is shown in FIG. 3 for one shot and one line of receivers. The modelled seismic traces in the gather have been generated using the basic model shown in FIG. 2. This is done by applying the isotropic acoustic wave equation to the model of FIG. 2 and then modelling the reflected and refracted signals as they would be detected. The modelled seismic shot gather is made up of individual traces at surface receiver positions showing pressure recorded as a function of time.

In general, the parameters of the model are estimated at a plurality of points set out in a grid or volume, but they may be estimated from any suitable parameterisation. The model is used to generate a modelled representation of the seismic data set. The predicted seismic data set is then compared to the real-world experimentally obtained seismic data set. Then, through use of a convergent numerical iteration, the parameters of the model are modified until the predicted seismic data set generated from the Earth model matches the actual observed seismic data to a sufficient degree of accuracy or until a predefined stopping criterion is met. Examples of this technique are illustrated in “An overview of full-waveform inversion in exploration geophysics”, J. Virieux and S. Operto, Geophysics Vol. 74 No. 6 and U.S. Pat. No. 7,725,266.

There are a number of inverse problem approaches that can be used to refine and optimise the starting model, and these will be described below. However, all approaches follow a generic approach in which the modelled parameters of the subsurface medium m are estimated such that synthetic data d(m) generated by the given forward model agrees with observed data d₀. This can be formulated as an optimisation problem to solve expression 1):

$${min}_{m} F ( m ) \qquad 1 )$$

where F(m) is a function designed to be smaller when d(m) is more similar to d₀. A common choice is to minimize the least squares misfit as set out in equation 2):

F(m)=½∥d(m)−d₀∥² 2)

This approach can, however, be generalised to include other misfit functions. Inverse problems of practical interest are often ill-posed without additional assumptions about the unknown parameters. Regularisation in the form of penalties or constraints on m can be used to enforce these assumptions by restricting the allowed solutions.
1. Here, m denotes medium parameters defined, for example, on a spatial grid, represented as a vector mϵR^{N}, where N is the number of discretised points in the model. In the context of acoustic waveform inversion, m could represent, for example, slowness squared (the reciprocal of velocity squared), slowness or Vₚ, amongst others.
2. The forward models and objective functions that define F(m) can be quite general. However, the present invention is particularly concerned with functions F(m) corresponding to waveform inversion problems and travel-time inversion problems. Two examples of waveform inversion problems are: conventional Full Waveform Inversion (FWI) and Adaptive Waveform Inversion (AWI). An overview of FWI techniques can be found in “An overview of full-waveform inversion in exploration geophysics”, J. Virieux and S. Operto. A typical, generalised FWI-type method involves the following steps:
1. Start from model m₀;
2. Evaluate the gradient of the objective function for the current model;
3. Find the step length α;
4. Subtract α times the gradient from the current model to obtain a new model; and
5. Iterate from step 2 using the new model until the objective function is minimised.

In AWI, model-dependent Wiener filters w(m) are defined which enable the modelled data to be fitted to the measured data. The method of AWI is described in United Kingdom Patent GB2509223B.

Finally, two examples of travel-time inversion problems are: first arrival travel-time tomography; and reflection travel-time tomography.

The present invention is applicable to all of the above-described methods. Whilst the mechanisms for each differ, in each case an iterative update is applied to a model, typically based on a residual between modelled data and measured data, although the model updates could be derived using any other method. The skilled person would readily understand how to apply the present invention to any of the known, described methods.

However, all of the above methods suffer from a technical problem that updates to a model may not converge towards a desired global minimum, resulting in an inaccurate model update and final model. The present invention, in embodiments, addresses these issues.

According to a first aspect of the present invention, there is provided a method of subsurface exploration, the method comprising generating a geophysical representation of a portion of the volume of the Earth from measurements of at least one observable physical quantity, and comprising the steps of: providing an observed geophysical data set derived from measurements of at least one observable physical quantity relating to the portion of the volume of the Earth; generating a predicted geophysical data set using a subsurface model of the portion of the Earth, the subsurface model having a spatial geometry and comprising a plurality of model coefficients representing at least one geophysical parameter; providing one or more objective functions operable to measure the similarity and/or dis-similarity between the observed and predicted geophysical datasets; iteratively modifying the subsurface model to minimise and/or maximise the one or more objective functions, wherein the or each iterative step modifies a subsurface model to produce an updated subsurface model and one or more iterative steps comprises: defining one or more directed paths through a subsurface model, the or each directed path being defined with respect to the spatial geometry of the subsurface model; defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and updating the subsurface model utilising the asymmetric controls; and providing an updated subsurface model of a portion of the Earth for subsurface exploration.

In one embodiment, the controls comprise constraints and/or penalties on the total amount by which a respective function of the model coefficients and/or updated model coefficients can increase or decrease in the direction of a respective directed path.

In one embodiment, at least one of the directed paths is substantially vertical.

In one embodiment, the at least one of the directed paths is in the direction of increasing depth in the subsurface model.

In one embodiment, the asymmetric controls are configured such that the controls are stronger in the direction of increasing depth in the subsurface model.

In one embodiment, the model coefficients represent seismic velocity and the controls are configured to reduce or prevent decreases in seismic velocity with increasing depth.

In one embodiment, one or more controls comprise an asymmetric directional hinge-loss constraint.

In one embodiment, one or more controls comprise a convex asymmetric directional hinge-loss constraint.

In one embodiment, the convex asymmetric directional hinge-loss constraint is operable to restrict a norm of variations of a function of the model coefficients along the or each respective directed path, such that the sum of the absolute values of a vector of the or each function of the model coefficients is constrained to be less than or equal to a positive value when the respective function is given by a hinge function applied to changes in the said function of the model coefficients along the said directed path such that the said hinge function acts to set either negative or positive changes to zero.

In one embodiment, the said hinge function comprises a shifted hinge-loss function, wherein the said variations are shifted by a finite amount and set to zero when the shifted entries become either negative or positive.

In one embodiment, the said hinge function comprises an asymmetric weighted hinge-loss function, wherein the said variations are multiplied by a weighting vector.

In one embodiment, the said weights and/or shifts are varied between steps of the iteration.

In one embodiment, the value of the directional hinge-loss constraint is varied between model updates.

In one embodiment, the said norm comprises a one-norm.

In one embodiment, the said norm comprises a p-norm which sums the p^{th} power of the entries followed by taking the p^{th}-root of the sum.

In one embodiment, the said norm comprises a Huber norm, operable to compute the two-norm for the small entries and the one-norm for the large entries.

In one embodiment, the norm comprises a functional derived from statistical distributions.

In one embodiment, the functional is derived from the student t distribution.

In one embodiment, the functional is derived from statistical distributions that measure how random variables change together.

In one embodiment, the functional is derived from covariances that measure how random variables change together.

In one embodiment, the said variations are replaced by higher-order derivatives.

In one embodiment, step b) further comprises transforming the said model coefficients by an invertible directional transform.

In one embodiment, the or each objective function comprises a partial-differential equation constrained optimisation problem.

In one embodiment, the partial differential equation constrained optimisation problem comprises a convex quadratic approximation to a non-convex objective function.

In one embodiment, at least one of said objective functions comprises a norm misfit objective function.

In one embodiment, at least one of said objective functions comprises an L₁-norm misfit objective function.

In one embodiment, at least one of said objective functions comprises a least-squares misfit objective function.

In one embodiment, step g) further comprises minimising the gradient of one or more of the objective functions with respect to said model coefficients.

In one embodiment, step g) is solved using adjoint-state methods.

In one embodiment, step g) is solved using full-space methods.

In one embodiment, the asymmetric controls are enforced on the Gauss-Newton descend directions of the model coefficients.

In one embodiment, prior geological information is utilised to determine the directed paths.

In one embodiment, prior geological information is utilised to determine the asymmetric controls.

In one embodiment, at least one of the asymmetric controls comprises an asymmetric penalty, and wherein the value of the penalty is variable for each iteration.

In one embodiment, the value of the penalty is decreased with increasing iterations.

In one embodiment, the value of the penalty is varied according to a predetermined function or empirical parameter.

In one embodiment, a weighting is applied to the one or more asymmetric controls, the weighting being dependent upon a model parameter.

In one embodiment, the weighting is dependent upon the spatial location in the subsurface model or spatial geometry of the subsurface model.

According to a second embodiment of the present invention, there is provided a method comprising generating a geophysical representation of a portion of the volume of the Earth from measurements of at least one observable physical quantity, and comprising the steps of: providing an observed geophysical data set derived from measurements of at least one observable physical quantity relating to the portion of the volume of the Earth; generating a predicted geophysical data set using a subsurface model of the portion of the Earth, the subsurface model having a spatial geometry and comprising a plurality of model coefficients representing at least one geophysical parameter; providing one or more objective functions operable to measure the similarity and/or dis-similarity between the observed and predicted geophysical datasets; iteratively modifying the subsurface model, wherein the or each step of the iteration modifies a subsurface model to produce an updated subsurface model and one or more steps of the iteration comprises: defining one or more directed paths through a subsurface model, the or each directed path being defined with respect to the spatial geometry of the subsurface model; defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and minimising and/or maximising the one or more controls with respect to the model coefficients of the subsurface model and/or updated subsurface model subject to the constraints upon allowable values of the objective function to produce an updated subsurface model; and providing an updated subsurface model of a portion of the Earth for subsurface exploration.

In one embodiment, the method further comprises, prior to step g): applying one or more further controls to one or more model parameters, the controls being selected from the group of: bound constraints; bound penalties; total variation constraints; total variation penalties; 11 constraints; 12 constraints; 11 penalties; 12 penalties; higher order total variation penalties; and higher order total variation constraints.

In one embodiment, the or each further control is varied with each iteration.

In one embodiment, said at least one geophysical parameter comprises one or more of: pressure wave velocity; shear wave velocity; pressure wave velocity anisotropy; or shear wave velocity anisotropy.

In one embodiment, said at least one observable physical quantity comprises pressure, particle velocity, particle acceleration or particle displacement.

In one embodiment, the observed data set and the predicted data set comprise values of a plurality of physical parameters.

In one embodiment, the observed geophysical data set comprises one or more of: seismic data; electromagnetic data; electrical data; magnetic data; or gravitational data.

In one embodiment, subsequent to step h), the method further comprises: utilising the updated subsurface model for subsurface exploration.

According to a third aspect of the present invention, there is provided a computer program product executable by a programmed or programmable processing apparatus, comprising one or more software portions for performing the steps of any one of the first or second aspects.

According to a fourth aspect of the present invention, there is provided a computer usable storage medium having a computer program product according to the third aspect stored thereon.

### BRIEF DESCRIPTION OF THE DRAWINGS

Embodiments of the present invention will now be described in detail with reference to the accompanying drawings, in which:

FIG. 1 is a schematic illustration of a typical seismic survey experiment in which seismic traces are obtained from an undersea portion of the Earth;

FIG. 2 is a schematic illustration of a basic starting model for full waveform inversion modelling;

FIG. 3 is a schematic illustration of modelled seismic trace data generated from the basic starting model of FIG. 2 for an individual seismic shot;

FIG. 4 shows a method according to a first embodiment of the present invention;

FIG. 5 shows a method according to a second embodiment of the present invention;

FIGS. 6a and 6b show a true reference target model and a poor starting model respectively;

FIGS. 7a and 7b show the results of an inversion problem solved without the use of total variation (TV) constraints;

FIGS. 8a, 8b and 8c show the results of the inversion problem solved with regular total variation (TV) constraints; and

FIGS. 9a to 9f show the results of a number of sequential iterations of an inversion problem solved in accordance with an embodiment of the present invention.

### DESCRIPTION OF EXEMPLARY EMBODIMENTS

The present invention provides an improved methodology for enabling improved convergence by including asymmetric constraints applied to the updated models.

In particular, the present invention is operable to constrain simultaneously the particular operational parameters whilst enforcing bound constraints to keep the parameters within a physically realistic range. Such total variation regularisation can improve the recovery of a high velocity perturbation to a smooth background model, removing artefacts caused by noise, limited data and ill-conditioning. Total variation-like constraints can make the inversion results significantly more robust to a poor initial model, leading to reasonable results in some cases where unconstrained variants of the method completely fail.

The following embodiments illustrate the application of the present invention in practice. The first embodiment outlines the general approach of the present invention. The second embodiment outlines a specific implementation in accordance with an embodiment.

The following embodiments are equally applicable to time, frequency, Laplace or other domains analysis. These aspects are to be considered to form part of the present disclosure and the skilled person would be readily aware of implementations of this.

The following embodiments can readily be applied to electro-magnetic, electric resistivity or gravimetric methods by the skilled person.

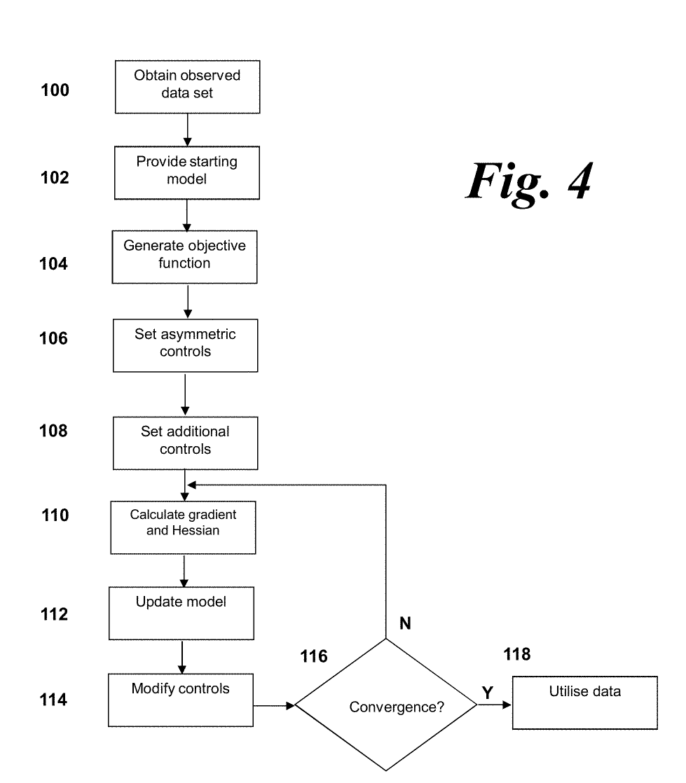

A method according to the present invention will now be described with reference to FIG. 4. FIG. 4 shows a flow diagram of a first embodiment of the present invention.

### Step 100: Obtain Observed Seismic Data Set

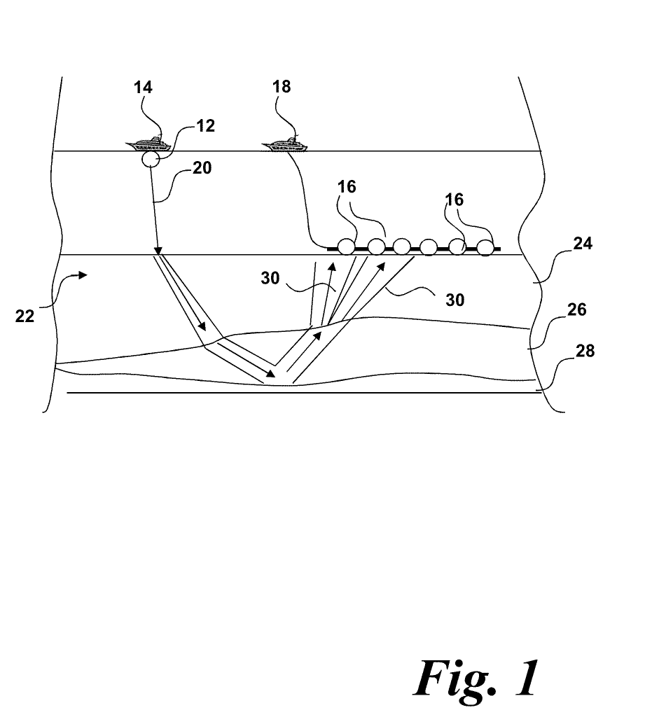

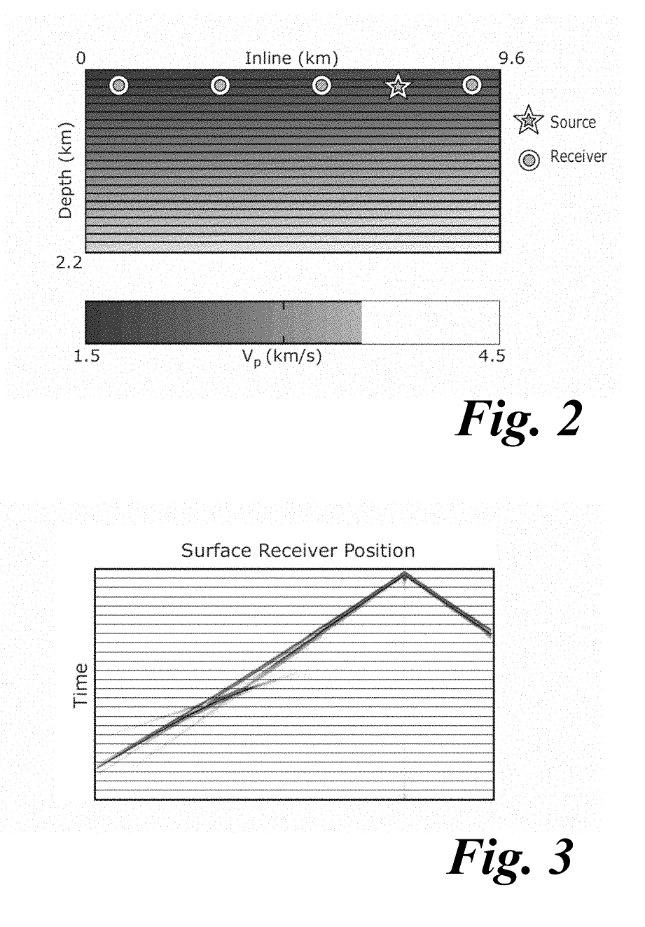

Initially, it is necessary to obtain a set of experimentally gathered seismic data in order to initiate subsurface exploration. This may be gathered by an experimental arrangement such as the set up shown and described with reference to FIG. 1.

The gathered seismic data may comprise the original data set. Alternatively, the gathered seismic data may optionally be pre-processed in various ways including by propagating numerically to regions of the surface or subsurface where experimental data have not been acquired directly. Alternatively, the gathered seismic data may be pre-processed utilising filters or other pre-processing elements to remove extraneous noise or background interference, for example. The skilled person would readily be able to design and undertake such pre-processing as might be necessary or desirable. With or without such pre-processing, the resultant seismic dataset representing experimentally-gathered data is known as an “observed seismic data set”.

As shown in FIG. 1, a large number of receivers or detectors 16 are positioned at well known positions on the surface of the portion of the Earth to be explored. The detectors 16 may be arranged in a two dimensional (such as a line) or a three dimensional (such as a grid or plurality of lines) arrangement. The physical location of the detectors 16 is known from, for example, location tracking devices such as GPS devices. Additionally, the location of the source 12 is also well known by similar location tracking means.

The observed seismic data set may comprise multiple source 12 emissions known in the art as “shots”. The data comprises pressure as a function of receiver position (on the x-axis) with respect to time (on the y-axis). This is because, in general, a detector such as a hydrophone measures the scalar pressure at its location. However, other arrangements may be used.

The seismic trace data comprises a plurality of observed data points. Each measured discrete data point has a minimum of seven associated location values three spatial dimensions (x, y and z) for receiver (or detector) position (r), three spatial dimensions (x, y, z) for source location (s), and one temporal dimension measuring the time of observation relative to the time of source initiation, together with pressure magnitude data. The seven coordinates for each discrete data point define its location in space and time.

The seismic trace data also comprises one or more measurement parameters which denote the physical property being measured. In this embodiment, a single measurement parameter, pressure is measured. The observed data set is defined as d(r,s) and, in this embodiment, is in the time domain. For clarity, the following discussion considers a single source-receiver pair and so r, s are not needed.

The actual gathering of the seismic data set is described here for clarity. However, this is not to be taken as limiting and the gathering of the data may or may not form part of the present invention. The present invention simply requires a real-world observed seismic data set upon which analysis can be performed to facilitate subsurface exploration of a portion of the Earth. The method now proceeds to step 102.

### Step 102: Provide Starting Model

At step 102, an initial starting model of the specified subsurface portion of the Earth is provided. The model may be provided in either a one dimensional, a two dimensional or a three dimensional form. Whilst the illustrated examples are of a two-dimensional form, the skilled person would be readily aware that the present invention is applicable to three dimensional approaches.

The generated model consists of values of the coefficient Vₚ and, possibly, other physical values or coefficients, typically defined over a discrete grid representing the subsurface. Such starting models are routinely generated and represent the general trends of the major features within the subsurface region to be modelled and could be readily generated by the skilled person. However, in the case of the present invention a less accurate initial model could be used. This may reduce the required time and resources to generate the starting model whilst still enabling accurate and improved —because the final model quality is superior in terms of sharpness of discontinuities-convergence.

The starting model may vary depending upon the inverse problem formulation used. For example, with conventional FWI, a predicted seismic data may be generated based on an analysis of the acoustic isotropic two-way wave equation as set out below in equation 3):

$$\frac{1}{{V}_{p}^{2}} \frac{{\partial }^{2} p}{\partial {t}^{2}} - ρ ∇ ( \frac{1}{ρ} ∇ p ) = s \qquad 3 )$$

where the acoustic pressure p and driving source s vary in both space and time, and the acoustic velocity Vₚ and density ρ vary in space. This equation applies to small-amplitude pressure waves propagating within an inhomogeneous, isotropic, non-attenuating, non-dispersive, stationary, fluid medium. It is relatively straightforward to add elastic effects, attenuation and anisotropy to the wave equation. Introduction of these parameters changes the detailed equations and numerical complexity, but not the general approach.

The wave equation 3) represents a linear relationship between a wave field p and the source s that generates the wave field. After discretisation (with, for example, finite differences) we can therefore write equation 28) as a matrix equation 4):

Ap=s 4)

where p and s are column vectors that represent the source and wavefield at discrete points in space and time, and A is a matrix that represents the discrete numerical implementation of the operator set out in equation 5):

$$A = \frac{1}{{V}_{p}^{2}} \frac{{\partial }^{2}}{\partial {t}^{2}} - ρ ∇ ( \frac{1}{ρ} ∇ ) \qquad 5 )$$

Although the wave equation represents a linear relationship between p and s, it also represents a non-linear relationship between a model m and wavefield p. Thus equation 5) can be rewritten as equation 6):

B(m)=p 6)

where m is a column vector that contains the model parameters. Commonly these will be the values of Vₚ (and ρ if density is an independent parameter) at every point in the model, but they may be any set of parameters that is sufficient to describe the model, for example slowness 1/Vₚ, acoustic modulus Vₚ² ρ, or impedance Vₚ ρ.

In equation 6), B is not a matrix. Instead it is a non-linear Green's function that describes how to calculate a wavefield p given a model m.

Once the model has been generated, the method then proceeds to step 104.

### Step 104: Generate Objective Function

At step 104, an objective (or misfit) function to be minimised is configured. Any suitable method may be used as required. For example, any of the FWI or AWI methods described earlier could be used with the present invention. In general, an objective function of the form:

F(m)=∥f(d₀,d(m),m,A,p,s, . . . )∥² 7)

could be used, where the objective function can depend on the observed and predicted data, model parameters, wave equation operator, predicted wavefield, source and other terms.

The specifics of this approach may vary in dependence upon the method used to iteratively solve the inverse problem. All applicable methods are considered to form part of the present invention.

For example, in the case of conventional FWI, the objective function is operable to compare the difference between the measured data set and a predicted seismic data set. Therefore, it is necessary to generate a predicted data set from the initial starting model created in step 102.

The predicted data is required to correspond to the same source-receiver location data positions as the actual measured trace data so that the modelled and observed data can be compared. In other words, the predicted data set corresponds discrete point to discrete point to the observed dataset. The predicted data set is generated for the same measurement parameter(s) at the same frequency or frequencies.

From the above analysis, predicted seismic data can be generated for one or more physical parameters in the time domain. If done in the frequency domain it could be done for one or more selected frequencies. Other domains may also be used to generate the data, for example the Laplace domain or the frequency-wavenumber domain. This forms the predicted seismic data set which is utilised as d(m).

In the case of AWI, an example of an objective function may be configured to measure the similarity or dis-similarity between a simple one-dimensional convolutional filter in time and a reference function that consists of only one non-zero value at zero lag.

The convolutional filter takes as an input all or part of the predicted data and from that generates as an output an approximation to all or part of the observed data. A filter is designed for each source-receiver pair to generate a set of coefficients specific to particular values. More than one filter may be designed in this step if required.

It is to be understood that the term “convolutional filter” in the present invention may have broad applicability. For example, the convolution may be non-causal, involve non-stationary convolution operations, or it may be applied in one or more dimensions, including spatial, temporal or other dimensions, the number of dimensions and/or number of data points on input need not the same as the number of dimensions or data points on output, the filter may vary in space, in time and/or in other dimensions, and it may involve post-processing following convolution.

The convolutional filter may comprise any generalised convolutional operation that can be described by a finite set of parameters that depend upon both the predicted and observed data, such that when the convolution and associated operations are applied to all or part of the predicted data an accurate or generally approximate model of the observed data is generated.

Based on the above, the objective function would then consist of some norm of these weighted coefficients divided by the same norm of the unweighted coefficients. If the L₂ norm is used here, then this objective function will provide the least-squares solution, but other norms (for example, the L₁ norm) are potentially utilisable.

The norm of the weighted coefficients must be normalised by the norm of the unweighted coefficients in this example otherwise the objective function could be simply minimised by driving the predicted data to large values, and hence driving the filter coefficients to small values.

In this example, the coefficients generated for each source receiver pair are weighted as a function of the modulus of the temporal lag. In other words, the coefficients are weighted based on the data position in time for a time domain analysis.

However, it is to be understood that other types of weighting could be used. For example, more complicated functions of the temporal lag are possible such as weighting with a Gaussian function of lag centred on zero lag.

In general two types of weighting are desirable; those that increase monotonically away from zero lag, such as the modulus, and those that decrease monotonically away from zero lag, such as a Gaussian weighting. The former type of weighting will lead to objective functions that should be minimised and the latter type will lead to objective functions that should be maximised. Combinations of these two types are also possible. The skilled person would readily understand how to design such objective functions and how to minimise or maximise them.

The method proceeds to step 106.

### Step 106: Set Asymmetric Controls

At step 106, asymmetric controls are added to the objective function formulation. The controls are either in the form of constraints (where a given parameter may not exceed a particular constraint value) or penalties (where a given parameter may exceed a particular threshold but is increasingly penalised the more it exceeds the threshold. In this example, both constraints and penalties are disclosed.

The controls are imposed by a regulariser that constrains the total variation of the physical model parameters per iteration along specified directed paths through the model, where the directed paths are defined in relation with the model spatial locations. In other words, the directed paths are defined in relation to the spatial geometry of the model. For example, a model parameter is only allowed to increase in some specified directed path through the model.

There may be one or more directed paths, and they may take any suitable form. For example, the directed paths may be straight lines, curves or a combination of the two. The directed paths may be configured to follow particular geometrical or geophysical features or aspects f the model, or they may be simple straight lines in a particular direction. For example, the directed paths may extend vertically through the model. In general, the vertical direction in the model will correspond to the gravitational direction in the real-world subsurface portion of the Earth that the model is intended to correspond to.

Inverse problems are often posed and iteratively solved without any assumptions about the parameters of the model which are unknown. However, regularisation in the form of constraints or penalties on the parameters of m can be used to enforce assumptions to assist the iterative convergence process.

In this example, m denotes medium parameters of the model on a spatial grid, represented as a vector mϵR^{N}, where N is the number of model parameters. In the context of acoustic waveform inversion, m could represent the square of slowness, or the reciprocal of the square of the velocity.

Therefore, since the velocity generally increases with depth, a constraint can be placed on m that penalises increases in slowness in the direction of increasing depth. As a result, downward jumps in velocity can be penalised. This can be done with an asymmetric, one dimensional total variation constraint that places pre-selected bounds on increases in the slowness or some function of slowness in the increasing depth direction. Similarly, the asymmetric total variation constraint can restrict decreases in velocity or some function or velocity.

The asymmetric constraints can be imposed, for example, as regularisers with a general form (set out in expression 8):

∥max(0,Dᵥm)∥₁≤ξ 8)

where Dᵥ is a difference matrix such that Dᵥm is a particular discretisation of the directional derivatives ∇m·v at each grid point, where v is the direction of the directed path, so that Dᵥ is the derivative along the directed path; and max(0,⋅) is interpreted in a component-wise sense. The strength parameter ξ controls the total amount of asymmetric total variation allowed in the direction v.

Using this formulation, particular biases can be imposed on the minimisation of the objective function. For example, the vector field v could be configured to have a bias in the direction of increasing depth. In the described example, where the downward jumps in velocity are penalised in the depth (vertical) direction, the derivative operator Dᵥ would be D_{z}.

This has multiple benefits. Having single-direction constraints enables the minimisation to be guided in a specific directed path through the model which is beneficial to reaching a more accurate model update. The effect of imposing such constraints is a restriction in the solution space (or objective function) allowed positions. That is, only models that obey the constraints are allowed, effectively reducing the size of the solution space, with the assumption that by discarding models with less physical likelihood we will reduce the number of local minima. This approach, however, does not ensure elimination of all local minima from the solution space.

The relative strength of the asymmetric constraint can be varied as appropriate. The parameter ξ controls the strength of the constraint. If ξ=0, then m is not allowed to increase in the direction v. For ξ>0, the sum of the non-negative directional derivatives in the v directions evaluated at each spatial location must be less than or equal to ξ. Note that v does not need to be constant through the model, and can represent any path through it.

Incorporating the directional derivative constraint into the generic inverse problem 7) leads to a minimisation of:

$${min}_{m} F ( m ) \\ s . t . {‖ max ( 0 , {D}_{υ} m ) ‖}_{1} \leq ξ \qquad 9 )$$

The type of asymmetrical or directional constraints which are imposed upon the objective function may be selected as required and may relate to one or more parameters of the model m as desired. The skilled person would be readily aware of the parameters which could be constrained.

In addition, whilst the above example has been illustrated with respect to the one-directional constraint on velocity with increasing depth, other arrangements could be contemplated. For example, an asymmetric directional constraint could be used to add regularisation to the sides of the model, where there are often artefacts due to limited data capture. Near the sides of the model, an asymmetric TV constraint could also be implemented in the horizontal direction.

Further, vector fields could be defined that account for more complicated structural assumptions. For example, if a point is considered to lie on a surface of substantially constant velocity, and the normal direction to this surface is known, then two orthogonal directions could be selected and two one directional TV constraints applied in these directions, with the aim of discouraging changes in velocity in directions that are tangent to the surface.

It is also possible for F to depend on additional variables not subject to the above constraints. For example:

$${min}_{m , y} F ( m , y ) + φ ( y ) \\ s . t . {‖ max ( 0 , {D}_{υ} m ) ‖}_{1} \leq ξ \qquad 10 )$$

This can also include convex constraints on y if ϕ is an indicator function that is zero when the constraint is satisfied and infinite otherwise.

A further alternative to the asymmetric constraint is a directional derivative shifted asymmetric constraint which only penalises differences larger than a threshold:

∥max(0,Dᵥm−ϵ)∥₁≤ξ 11)

Another alternative is to set the asymmetric constraint as a penalty term added to the functional, where positive changes (or negative changes) in the specified direction are allowed but they increase the total value of the functional. Therefore, the inverse problem will prefer solutions where the penalty term is minimised.

The method may proceed, optionally, to step 108. Alternatively the method may proceed directly to step 110.

### Step 108: Set Additional Controls

In addition to the asymmetric controls set out above in step 106, other constraints or penalties (i.e. controls) may also be introduced. This may be advantageous in particular situations and may assist in, for example, noise reduction or artefact elimination.

The additional constraints may comprise bound constraints, for example:

mₗϵ[bₗ,Bₗ] 12)

where bₗ and Bₗ are the lower and upper bounds of the l^{th} model parameter respectively. Such bounded constraints may be based on empirical knowledge or on physical models which maintain particular values within reasonable physical ranges.

Additionally or alternatively, the applied constraints may comprise total variation constraints, such as set out in expression 13) below:

∥m∥_{TV}≤τ 13)

where τ is the size of the TV ball. This expression may also be written as ∥Dm∥_{1,2}≤τ which equals τₜ∥(Dm)ₗ∥, i.e. a sum of the l₂ norms of the discrete gradients of m summed over all the spatial grid points or over all the discrete or continuous locations in the model. Such an isotropic TV constraint is particularly useful for limiting artefacts caused by directional constraints.

Additionally or alternatively, directional TV constraints of the form ∥Dᵥm∥₁≤τ, representing a discretisation of the directional derivatives, and limiting the total variation of m in the direction v. This equally penalises increases and decreases of m in the v direction.

Once the additional constraints have been added if required, the method proceeds to step 110.

### Step 110: Calculate Functional Gradient and Optional Hessian

This step may be done by any suitable method. In conventional FWI, a predicted data set is generated from the model and the objective function is then used to determine a residual from the differences between the observed data set and the predicted data set. The gradient is then calculated, for example using an adjoint state method. If implemented, the Hessian can be approximated in a variety of ways, for example we can use the diagonal elements only of some approximation to the full Hessian.

The gradient direction and a Hessian approximation can be derived from the FWI functional by, for example, following the method described subsequently in relation to step 210.

In the case of the AWI method, the method seeks to minimise the misfit between the convolutional and reference filters. In one embodiment, the gradient of the objective functional is obtained with adjoint-state methods, minimising the weighted filter coefficients.

The method proceeds to step 112.

### Step 112: Update Model

Once the gradient direction and Hessian, approximations or exact if affordable, are computed, the method proceeds to calculate the model update.

In each case, multiple approaches to can be used to find local minimisers of the nonconvex optimisation problem.

$${min}_{m} F ( m ) \\ s . t . m ∈ {C}_{j} j = 1 , … , J \qquad 14 )$$

where F is differentiable and Cⱼ are convex and represent the different constraints imposed in to the objective function. One advantageous approach is a scaled gradient projection (SGP), which is an implementation of majorisation minimisation to reduce F(m) while satisfying the constraints specified in steps 106 and 108.

A generic majorisation minimisation approach would proceed by constructing at the current model estimate m^{k} an upper bound Gₖ(m)≥F(m) such that Gₖ(m^{k})≥F(m^{k}). By letting: 15)

$${m}^{k + 1} = {arg min}_{m ∈ {C}_{j}} {G}_{k} ( m ) \qquad 15 )$$

It follows that:

F(m^{k+1})≤G(m^{k+1})≤G(mₖ)=F(m^{k}) 16)

and m^{k+1}ϵ Cⱼ. If the Cⱼ are convex sets and the Gₖ are convex functions, then each iteration k requires solving a convex sub-problem for which many efficient and known methods are available.

While arbitrary Gₖ satisfying the above conditions does not guarantee convergence of m^{k}, specific selection may do so. For example, if ΔF is Lipschitz continuous then ΔF(m^{k}) can be used with a positive definite approximation H^{k} to the Hessian of F at m^{k} to define a quadratic approximation:

Qₖ(m)=F(m^{k})+<m−m^{k},∇F(m^{k})>+½<m−m^{k},H^{k}(m−m^{k})> 17)

An alternative approach is to use scaled gradient projection (SGP) which consists of iterating:

$${m}^{k + 1} = {arg min}_{m ∈ {C}_{j}} {Q}_{k} ( m ) \qquad 18 )$$

This approach will converge if it is ensured that the smallest eigenvalue of Hⁿ is sufficiently large. The method can still converge even when Qₙ is not an upper bound of F. Hⁿ can also be adaptively scaled to prefer large step sizes while keeping the step size small enough to guarantee sufficient descent of F and thereby to guarantee convergence to a stationary point.

Alternative methods may be used. For example, a Lagrangian based algorithm such as the method of multipliers, a quadratic penalty method or a hybrid of the two could be used to devise iterative schemes that solve easier sub-problems that only require the m^{k+1} iterates to approximately satisfy the constraints. If the projections onto the Cⱼ are expensive, this could be valuable.

For any useful measure of misfit or similarity, the predicted seismic data set will move towards the observed seismic data set. The underlying assumption is that when the predicted data move towards the observed, the updated models converge towards the model that represents the real Earth's subsurface. This assumption will be satisfied provided that the objective function definition and the constraints are correctly set to avoid falling in local minima.

The method now proceeds to step 114.

### Step 114: Modify Controls

At step 114, it is determined whether the controls should be modified before the next iteration of the method. This step is optional and need not be included, in which case the constraints set in step 108 or in steps 108 and 110 remain the same for further iterations.

By modifying the constraints and/or penalties with each iteration or group of iterations, the iterative process can be guided to better solutions by adjusting the constraints as the method proceeds. For example, the constraints and/or penalties may be set to be strong or restrictive for early iterations to ensure that the model updates progress in a particular direction, with the constraints being relaxed as the iteration progresses.

This has advantages in numerous applications. For example, consider the situation where an inverse problem approach is utilised to recover earth models including high velocity salt bodies. If the initial velocity model is not highly accurate, conventional FWI methods would tend to converge to local minima that may correctly identify the top of the salt body but not the bottom region. Such methods tend to be bad local minimisers that place the bottom of the salt body too high or that are dominated by spurious artefacts, such that sensible results are not derived below the top boundary of the salt body.

The asymmetric directional derivative constraint in the depth direction prevents the method from getting stuck in these local minima by discouraging downward jumps in velocity. With a strong asymmetric constraint, this has the effect of extending the high velocity salt region downward. This, therefore, provides an automated approach to the manual process of “salt flooding” where velocities are directly manipulated to extend them downward.

However, it may not be desirable to maintain a strong constraint through all the iterations because it would then be impossible to recover fine details in the model at later iterations. Therefore, a process may be implemented whereby the constraint is relaxed according to a continuation strategy that slowly increases the parameter with each iteration of the method thus relaxing the asymmetric TV constraint as iterations proceed and allowing the updates to introduce more structure in the model.

This forces early velocity models to be nearly monotonically increasing in depth, while more downward jumps are allowed during later iterations. This improves the solution path so that the method avoids local minima. This applies particularly to regions just below the top of a salt body. Moreover, this approach still allows fine details to be modelled in later iterations when the constraint is weaker.

However, there is a trade-off between the effectiveness of this approach and the expense of the continuation strategy with increasing iteration. Increasing slowly is more effective for avoiding poor and inaccurate local minima but also more computationally expensive.

One optional approach to implementing the changes with iteration is to utilise both a TV constraint and an asymmetric directional derivative constraint.

Consider a TV constraint ∥Dm∥_{TV}≤τ and an asymmetric directional derivative constraint ∥max(0, Dᵥm)∥₁≤ξ. A sequence of parameters τ_{b} and ξ_{b} can be defined, where b indexes the stage of the strategy (b may or may not correspond directly to the iteration step k). Based on this, for parameters τ₀>0, η_{τ}≥1, ξ₀>0 and η_{ϵ}≥1 it can be defined:

τ_{b}=τ₀η_{τ}^{b} 19)

And

ε_{b}=ε₀η_{ε}^{b} 20)

For each b, some number of iterations can be computed before the τ and ξ values are recalculated and increased before the next iteration.

If η_{τ}=η_{ε}=1 then no variations occur with each iteration and τ₀ and ξ₀ are used for all iterations.

The procedure of relaxing the constraint parameters with increasing k iterations can also be, optionally, combined with a frequency continuation strategy. For example, this may result in an implementation where, for each b, only low frequency data is fitted at first, with the method gradually including higher frequencies as the iterations proceed.

The values for ξ₀ may be estimated based on empirical data, or on known parameters of the model. The starting values for the constraint parameters are generally selected to be small (i.e. to provide a strong constraint) and are then increased at a particular rate.

The rate of increase may be selected to follow a particular algorithm or function. For example, the parameters may be increased at an exponential rate with each k^{th} iteration. This may result in the final parameters being twice as large as the initial parameters. Alternatively, the change in ξ and/or τ may follow another function, or may be tied to particular parameter value (e.g. some form of the residual or other error bound).

Whilst, empirically, it has been found to be advantageous to start with strong constraints and increase the parameters slowly for the initial iterations, this need not be so. For particular systems, it may be more appropriate to start with weaker constraints and then focus them down to a stronger system in later iterations.

In addition, the TV constraint need not be varied and need not start with a small parameter value, since the TV constraint is, in one embodiment, implemented to prevent artefacts caused by the asymmetric constraint.

The method proceeds to step 116.

### Step 116: Convergence Criteria Met?

At step 116 it is determined whether convergence criteria have been met. For example, when the method is deemed to have reached convergence when the difference between the data sets (or the residual in each case) reaches a threshold percentage or other value. Alternatively, the stopping criterion may be a maximum number of iterations; or any general combination of the two above-mentioned criteria. If the criteria as set out above have been met, then the method proceeds to step 118 and finishes with the resultant Earth model generated. If the criteria have not been met, then the method proceeds back to repeat steps 110 to 114 as discussed above for a k+1^{th} iteration.

### Step 118: Finish

When, at step 118, it has been determined that the convergence criteria has been met, the method finishes and the modelled subsurface portion of the Earth is deemed to be sufficiently accurate to be used for subsurface exploration. This may involve the direct interpretation of the recovered model, and/or involve the process of depth-migration to generate a subsurface reflectivity image to be used for the identification of subsurface features such as cavities or channels which may contain natural resources such as hydrocarbons. Examples of such hydrocarbons are oil and natural gas.

Once these features have been identified in the subsurface model and/or reflectivity image, then measures can be taken to investigate these resources. For example, survey vessels or vehicles may be dispatched to drill pilot holes to determine whether natural resources are indeed present in these areas.

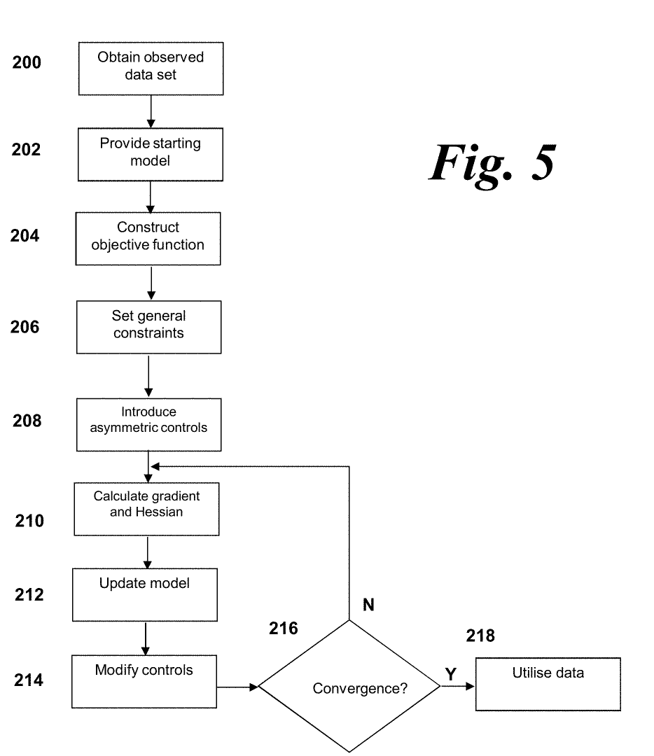

A second embodiment of the invention is illustrated in FIG. 5. The second embodiment details a specific, non-limiting example of the process in detail.

### Step 200: Obtain Observed Seismic Data Set

Step 200 corresponds substantially to method step 100 of the previous embodiment. Therefore, this will not be described again here. Only the steps that are new to this embodiment of the method of the present invention will be described. The method now proceeds to step 202.

### Step 202: Provide Starting Model

At step 202, an initial starting model of the specified subsurface portion of the Earth is provided. The model may be provided in either a one dimensional, a two dimensional or a three dimensional form. Whilst the illustrated examples are of two-dimensional form, the skilled person would be readily aware that the present invention is applicable to approaches utilising other dimensional forms.

The model is generated in this step in accordance with step 102 above.

In this example, which uses a FWI approach, the initial starting model is a best guess estimate for the subsurface region to be modelled. This includes parameters of the model which are to be inputted into the resulting partial differential equations (PDEs) to describe the response of the model to a source excitation modelled by the source function sᵢ.

The generated model consists of values of the parameter Vₚ and, possibly, other physical values or coefficients over a discrete grid representing the subsurface. Such starting models are routinely generated and represent the general trends of the major features within the subsurface region to be modelled and could be readily generated by the skilled person.

The method then proceeds to step 204.

### Step 204: Construct Objective Function

At step 204, an objective (or misfit) function is configured. In this embodiment, the method of Full Waveform Inversion (FWI) is utilised. This is based upon a wave equation written as a PDE which describes the wavefield resulting from the external excitation (the source).

The objective function for FWI is:

F(m)=½∥Mp−d₀∥² 21)

The model m corresponds to the reciprocal of the velocity squared, to be a real vector mϵR^{N}

where N is the number of points in the spatial discretisation. M is the operator that projects the wavefields onto the receiver locations. There is an implicit sum over all sources and receivers for the objective function.

The method then proceeds to step 206.

### Step 206: Set General Constraints

To make the inverse problem more well posed, the constraint m ϵ C can be added, where C is a convex set. Expression 22) can then be solved.

$${min}_{m} F ( m ) \\ s . t . m ∈ C \qquad 22 )$$

For example, a box constraint on the elements of m could be imposed by setting C_{box}={m: mᵢϵ [bᵢ,Bᵢ]}. The only modification of expression22) is to replace the Δm update by:

$$Δ m = {arg min}_{m ∈ {R}^{N}} Δ {m}^{T} ∇ F ( {m}^{k} ) + \frac{1}{2} Δ {m}^{T} {H}^{k} Δ m \\ s . t . {m}^{k} + Δ m ∈ {C}_{box} \qquad 23 )$$

Total variation (TV) constraints can also be added to the discretised model. If m is represented as an N₁×N₂ image, a TV constraint can be defined as:

$$\begin{matrix}{‖ m ‖}_{TV} = \frac{1}{h} {\sum }_{ij} \sqrt{{( {m}_{i + 1 , j} - {m}_{i , j} )}^{2} + {( {m}_{i , j + 1} - {m}_{i , j} )}^{2}} \\ = {\sum }_{ij} \frac{1}{h} ‖ [ \begin{matrix}( {m}_{i , j + 1} - {m}_{i , j} ) \\ ( {m}_{i + 1 , j} - {m}_{i , j} )\end{matrix} ] ‖ ,\end{matrix} \qquad 24 )$$

which represents a sum of the l₂ norms of the discrete gradient at each point in the discretised model, with the assumption that Neumann boundary conditions apply so that these differences are zero at the boundary. ∥m∥_{TV} can be expressed more compactly by defining a difference operator D such that Dₘ is a concatenation of the discrete gradients and (Dₘ)ₙ denotes the vector corresponding to the discrete gradient at the location indexed by n, where n=1, . . . , N₁N₂:

$${‖ m ‖}_{TV} = {‖ Dm ‖}_{1 , 2} := {\sum }_{n = 1}^{N} ‖ {( Dm )}_{n} ‖ \qquad 25 )$$

The constraints of mᵢ ϵ [bᵢ, Bᵢ] and ∥m∥TV≤τ are then added, providing a TV constrained problem to be solved of:

$${min}_{m} F ( m ) s . t . {m}_{i} ∈ [ {b}_{i} , {B}_{i} ] and {‖ m ‖}_{TV} \leq τ \qquad 26 )$$

A weighted TV constraint could also be applied if required, where different parts of the model have different relative contributions to the TV norm, by introducing a diagonal matrix in front of the derivative matrix D, where the values of the diagonal entries in the new matrix control the relative contribution.

The method proceeds to step 208.

### Step 208: Introduce Asymmetric Controls

At step 208, asymmetric controls are added. These may apply to velocity since, for example, velocity generally increases with depth. Therefore, an asymmetric control may be introduced which penalises downward jumps in velocity without affecting upward jumps in velocity with each iteration. In this example, an asymmetric, one dimensional total variation constraint is used which penalises increases in the slowness squared in the depth direction.

The constraint:

∥max(0,D_{z}m)∥₁≤ξ 27)

is introduced, where “max” is understood to relate to particular components such that

$${‖ max ( 0 , {D}_{z} m ) ‖}_{1} = {\sum }_{ij}^{ } max ( 0 , \frac{1}{h} ( {m}_{i + 1 , j} - {m}_{i , j} ) ) \qquad 28 )$$

The constraint in expression 28) does not penalise velocities in the horizontal direction, only in the vertical (depth) direction.

positive depth weights may also be utilised such that:

$${\sum }_{ij}^{ } max ( 0 , \frac{{γ}_{i}}{h} ( {m}_{i + 1 , j} - {m}_{i , j} ) ) \leq ξ \qquad 29 )$$

where γᵢ is a weight parameter that depends on depth position i. The rationale for adding weights is that in the deeper regions of the model the value of the parameter m (slowness squared) is smaller than in the shallow parts because typically seismic velocities increase with depth. Increasing the value of the weights with depth helps balance the contribution deficit of the deeper parts of the model to the asymmetric total variation constraint.

Further, the use of such weights may have advantages in terms of encouraging deeper placement of discontinuities when the weights are designed to overcompensate for the above mentioned contribution deficit.

In addition, the constraints can be varied with each iteration. This is known as a continuation strategy. The ξ parameter can vary with some or all of the iterations. For example, ξ may start in early iterations (where k is small) with a small value (e.g. 0 or close to zero) such that m is totally or heavily constrained in one direction for one or more parameters.

As the iterations continue (with higher k values), the value of the ξ parameter may be allowed to increase gradually for each successive iteration (e.g. each low to high pass through the frequency batches). In other words, the asymmetric constraint is relaxed as the iteration continues, which encourages the initial velocity estimate to be nearly monotonically increasing in depth initially. As ξ increases, more downward jumps are allowed.

A continuation strategy may be implemented such that the parameter is varied in accordance with a measured parameter (for example, the residual in a particular direction or orientation).

Once the asymmetric controls have been implemented, the method proceeds to step 210.

### Step 210: Calculate Functional Gradient and Optional Hessian

A first step in FWI is to find the solution of the PDE that represents the wave equation that generates the predicted data utilised by the objective function in equation 21). This step consists of solving the wave equation using numerical methods.

The gradient of the FWI objective function at iteration k is:

$${∇}_{m} F ( {m}^{k} ) = {p ( {m}^{k} )}^{⊤} {( \frac{\partial α}{\partial m} )}^{⊤} {α}^{- ⊤} ( Mp ( {m}^{k} ) - {d}_{0} ) \qquad 30 )$$

and the Hessian approximation for the FWI objective function we will use has the form:

$${H}^{k} = {p ( {m}^{k} )}^{⊤} {( \frac{\partial α}{\partial m} )}^{⊤} ( \frac{\partial α}{\partial m} ) p ( {m}^{k} ) \qquad 31 )$$

where equation 31) only populates the diagonal of a simplified version of the full Hessian.

Ultimately gradients and Hessians from separate shots are combined (summed) to obtain a unique gradient and Hessian for the model update.

The method then proceeds to step 212.

### Step 212: Update Model

At step 212, the model is updated using the values obtained in step 210 as constrained by the asymmetric constraint plus any other constraints set in steps 208 and 206 respectively.

To update the model, it is necessary to solve a convex sub-problem. That is, given a gradient direction, a Hessian and a starting model m^{k}, an update Δm is sought such that the updated model m^{k+1}=m^{k}+Δm satisfies the various constraints specified (box, TV and asymmetric TV). The convex sub-problem can be posed as follows:

$$Δ m = {arg min}_{Δ m} Δ {m}^{T} ∇ F ( {m}^{k} ) + \frac{1}{2} Δ {m}^{T} ( {H}^{k} + {c}_{k} I ) Δ m \\ s . t . {m}_{i}^{k} + Δ {m}_{i} ∈ [ bi , Bi ] , {‖ {m}^{k} + Δ m ‖}_{TV} \leq τ \\ and ‖ {max ( 0 , {D}_{z} ( {m}^{k} + Δ m ) ‖}_{1} \leq ξ \qquad 31 )$$

An effective approach is to use a modification of the primal dual hybrid gradient (PDHG) method to find a saddle point of:

$$( Δ m , {λ}_{1} , {λ}_{2} ) = Δ {m}^{T} ∇ F ( {m}^{k} ) + Δ {m}^{T} ( {H}^{k} + {c}_{k} I ) Δ m + {g}_{B} ( {m}^{k} + Δ m ) + {λ}_{1}^{T} D ( {m}^{k} + Δ m ) - τ {‖ {λ}_{1} ‖}_{∞ , 2} + {λ}_{2}^{T} {D}_{z} ( {m}^{k} + Δ m ) - ξmax ( {λ}_{2} ) - {g}_{\geq 0} ( {λ}_{2} ) \qquad 32 )$$

where λ₁ and λ₂ represent the Lagrange multipliers for each TV constraint, the regular and the asymmetric respectively.
The new terms introduced in equation 32) are described below, where g_{B}(m) is an indicator function for the bound constraints as defined below:

$${g}_{B} ( m ) = \{ \begin{matrix}0 & if {m}_{i} ∈ [ {b}_{i} , {B}_{i} ] \\ ∞ & otherwise\end{matrix} \qquad 33 )$$

and g_{≥0} denotes an indicator function defined by:

$${g}_{\geq 0} ( {λ}_{2} ) = \{ \begin{matrix}0 & if {λ}_{2} \geq 0 \\ ∞ , & otherwise\end{matrix} \qquad 34 )$$

The ∥.∥_{∞,2} term is using mixed norm notation to denote the dual norm ∥.∥_{1,2}. This approach takes the maximum instead of the sum of the l₂ norms so that ∥Dm∥_{∞,2}=maxₙ∥Dm∥. The total variation (TV) constraints are introduced in the saddle point problem (Lagrangian) as Lagrange multipliers. For the first constraint, associated with λ₁ we can write:

$${sup }_{{λ}_{1}} {λ}_{1}^{T} D ( {m}^{k} + Δ m ) - τ {‖ {λ}_{1} ‖}_{∞ .2} \qquad 35 )$$

which equals the indicator function:

$$\{ \begin{matrix}0 & if {‖ D ( {m}^{k} + Δ m ) ‖}_{1.2} \leq τ \\ ∞ , & otherwise\end{matrix} \qquad 36 )$$

For the second constraint, associated with λ₂:

$${sup }_{{λ}_{2}} {λ}_{2}^{T} {D}_{z} ( {m}^{k} + Δ m ) - ξmax ( {λ}_{2} ) - {g}_{\geq 0} ( {λ}_{2} ) \qquad 37 )$$

which equals the indicator function:

$$\{ \begin{matrix}0 & if ‖ max {( 0 , Dz ( {m}^{k} + Δ m ) ‖}_{1} \leq ξ \\ ∞ , & otherwise\end{matrix} \qquad 38 )$$

The indicator functions described above can be interpreted as a form of strict penalties, where the saddle problem solution has to be such that the value of the indicator functions is always zero, therefore enforcing the constraints to be satisfied. To find a saddle point of 32), the modified PDHG method requires iterating

$${λ}_{1}^{q + 1} = {λ}_{1}^{q} + δ D ( {m}^{k} + Δ {m}^{q} ) - {\prod }_{‖ \cdot ‖ 1 , 2 \leq τδ}^{ } ( {λ}_{1}^{q} + δ D ( {m}^{k} + Δ {m}^{q} ) ) \\ {λ}_{2}^{q + 1} = {λ}_{2}^{q} + δ {D}_{z} ( {m}^{k} + Δ {m}^{q} ) - {\prod }_{‖ max ( 0 , . ) ‖ 1 \leq ξδ}^{ } ( {λ}_{2}^{q} + δ {D}_{z} ( {m}^{k} + Δ {m}^{q} ) ) \\ Δ {m}_{i}^{q + 1} = max ( ( bi - {m}_{i}^{k} ) , min ( ( {B}_{i} - {m}_{i}^{k} ) , [ {( {H}^{k} + ( {c}_{k} + \frac{1}{α} ) I )}^{- 1} {( - ∇ F ( {m}^{k} ) + \frac{Δ {m}^{q}}{α} - {D}^{T} ( 2 {λ}_{1}^{q + 1} - {λ}_{1}^{q} ) - {D}_{z}^{T} ( 2 {λ}_{2}^{q + 1} - {λ}_{2}^{q} ) ) ]}_{i} ) ) \qquad 39 )$$

where q is the iteration index and the Π symbols are projection operators onto the TV bounds corresponding to each constraint. The values of α and δ control the step size of the updates.

For any useful measure of misfit or similarity, the predicted seismic data set will move towards the observed seismic data set consistently with the objective function misfit definition. The underlying assumption is that when the predicted data move towards the observed, the updated models converge towards the model that represents the real Earth's subsurface. This assumption will be satisfied provided that the objective function definition and the constraints are correctly set to avoid falling in local minima.

The method now proceeds to step 214.

### Step 214: Modify Constraints

As set out for step 114, at step 214 it is determined whether the constraints should be modified before the next iteration of the method.

By modifying the constraints with each iteration or group of iterations, the iterative process can be guided to better solution by adjusting the constraints as the method proceeds. For example, the constraints may be set to be strong or restrictive for early iterations to ensure that the model updates progress in a particular direction, with the constraints being relaxed as the iteration progresses.

The asymmetric directional derivative constraint in the depth direction prevents the method from getting stuck in these local minima by discouraging downward jumps in velocity. With a strong constraint, this has the effect of extending the high velocity salt region downward. This, therefore, provides an automated approach to the manual process of “salt flooding” where velocities are directly manipulated to extend them downward.

Once the modifications have been completed, the method proceeds to step 216.

### Step 216: Convergence Criteria Met?

At step 216 it is determined whether convergence criteria have been met. For example, when the method is deemed to have reached convergence when the difference between the data sets reaches a threshold percentage. Alternatively, the stopping criterion may be a maximum number of iterations; or any general combination of the two above-mentioned criteria. If the criteria as set out above have been met, then the method proceeds to step 218 and finishes with the resultant Earth model generated. If the criteria have not been met, then the method proceeds back to repeat steps 210 to 214 as discussed above.

### Step 218: Finish

When, at step 218, it has been determined that the convergence criteria has been met, the method finishes and the modelled subsurface portion of the Earth is deemed to be sufficiently accurate to be used for subsurface exploration. This may involve the direct interpretation of the recovered model, and/or involve the process of depth-migration to generate a subsurface reflectivity image to be used for the identification of subsurface features such as cavities or channels which may contain natural resources such as hydrocarbons. Examples of such hydrocarbons are oil and natural gas.

Once these features have been identified in the subsurface model and/or reflectivity image, then measures can be taken to investigate these resources. For example, survey vessels or vehicles may be dispatched to drill pilot holes to determine whether natural resources are indeed present in these areas.

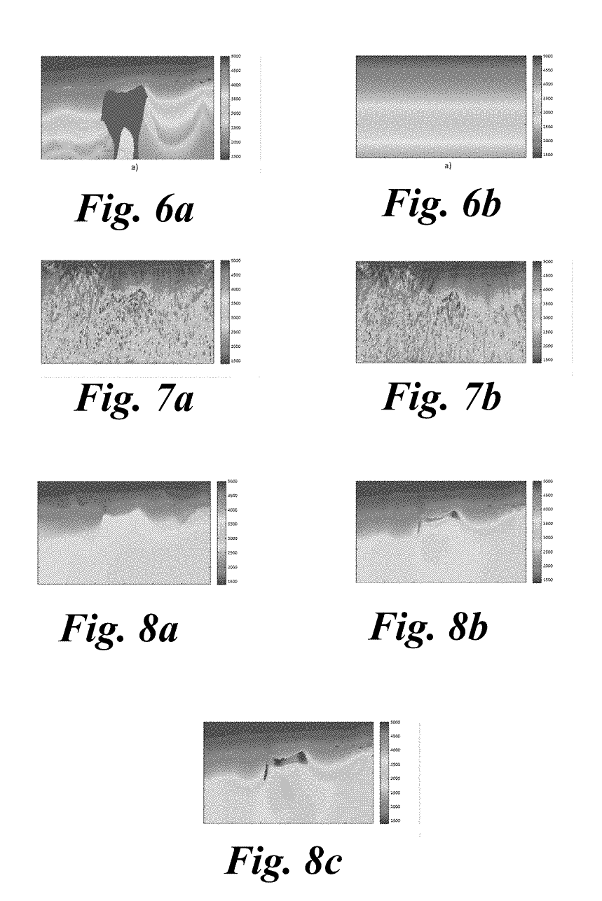

An example of the effectiveness of the method of the present invention is shown with respect to FIGS. 6 to 9. FIG. 6a shows a target model and FIG. 6b shows a poor initial model which is to be used as a starting model for the following inversion processes.

FIGS. 7a and 7b show the results of a number of iterations of an inversion method without any regular total variation (TV) or asymmetric TV constraints. The method starts from the initial model of FIG. 6b. FIG. 7b shows the result after twice the number of iterations of the result shown in FIG. 7a. As shown, the quality of the resolved model is poor and it is clear that the model is not converging to a correct global minimum.

A further example is shown in FIGS. 8a to 8c. FIGS. 8a to 8c show the results of an inversion method in which regular (two-sided/symmetrical) TV constraints are applied. Again, the method starts from the model of FIG. 6b.

FIG. 8a show the result for a strong value of the TV constraint. FIG. 8b show the result after a subsequent iteration after relaxing the TV constraint. Finally, FIG. 8c show the result after yet another subsequent iteration after relaxing again the TV constraint. As shown, the results are improved with respect to the previously-described model. In particular, the upper region of the target salt body is resolved. However, deeper, high velocity elements of the salt body are not correctly resolved.

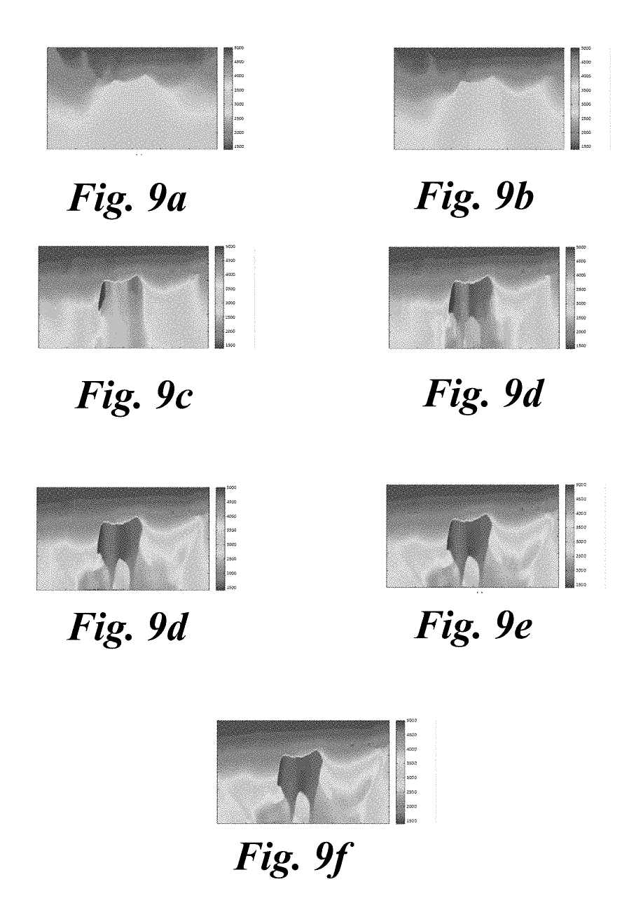

Finally, FIGS. 9a to 9f show subsequent iterations using the method of the second embodiment in which one-sided (or asymmetric) constraints are implemented in accordance with the present invention. As shown, the method clearly converges to an accurate final model which is close to the target model.

As shown in these examples, without the use of constraints, an iterative inversion problem relies upon having a good initial starting model to reach an accurate convergence. In general, a method without any constraints tends to get stuck at local minima. This is rarely improved when using just bound constraints or TV constraints. Therefore, to address these problems and discourage the iterative method getting stuck in local minima that have spurious downward jumps in velocity, the asymmetric TV constraint approach of the present invention can be utilised.

In addition, the examples shown in FIG. 9 use a method which implements a continuation strategy whereby the ξ parameter is varied with some or all of the iterations. In this example, ξ starts with a small value and gradually increases for each successive low to high pass through the frequency batches. This encourages the initial velocity estimate to be nearly monotonically increasing in depth.

As ξ increases, more downward jumps are allowed. The sequence of ξ parameters as a fraction of ∥max(0, Dzm)∥₁ is chosen to be 0.01; 0.05; 0.10; 0.15; 0.20; 0.25; 0.40; 0.90 respectively. The τ parameter is fixed at 0.9τ throughout.

Although small values of ξ may result in additional vertical artefacts, the continuation strategy is effective at preventing the method from getting stuck at a poor solution. As ξ increases, more downward jumps in velocity are allowed, and the model error continues to significantly decrease during each pass.

Clearly, the use of the asymmetric TV constraints results in significant improvement over the other methods. Only the asymmetric constraint model has the ability to recover the correct model (as can be seen from a comparison of results between FIGS. 6a and 9f). Therefore, even with a poor initial model, the asymmetric TV constraint approach of the present invention is able to recover the main features of the ground model.

The selected values of the x and parameters are, in embodiments, chosen to be proportional to values corresponding to the true solution. Although the true solution is not known in advance, it may still be reasonable base the parameter choices on estimates of its total variation (or asymmetric TV). It is also possible to develop continuation strategies that do rely on any assumptions about the solution but that are still effective at regularizing early passes through the frequency batches to prevent the method from stagnating at poor solutions.

Variations on the above method fall within the scope of the present application. For example, the method may be implemented in which the roles of the objective function and the control parameter are reversed such that the control parameter is minimised (or maximised as appropriate) and the objective function serves as the constraint. In this configuration, the value of the objective function must, for example, lie above or below a predetermined threshold, depending upon whether the iteration is configured to minimise or maximise. This may be defined as one or more (or a set) of allowable values of the objective function. For example, these values may typically be an upper threshold for an objective function that measures dis-similarity, and will be a lower threshold for an objective function that measures similarity.

Therefore, the method may seek a model that has the lowest possible positive variation subject to the misfit between the observed and predicted data not being higher than the noise level.

Further, the present invention is also applicable to the adjoint state method of FWI, AWI, Travel Time Tomography or any other seismic or non-seismic inversion method.

The above embodiments may be implemented in the time domain or the frequency domain. In the frequency domain, the different frequency components may be extracted in any known method, for example, through the use of a Fourier transform. Fourier transforms and associated coefficients are well known in the art. Since only a few frequency components may be required, a discrete Fourier transform may be computed from the inputted seismic trace data. Alternatively, a conventional fast Fourier transform (FFT) approach may be used. As a further alternative, partial or full Fourier transforms may be used. The Fourier transform may be taken with respect to complex or real valued frequencies.

Any number of observed data sets at one or more frequencies may be extracted. For example, a plurality of observed data sets may be provided having frequency components of, for example, 4.5 Hz, 5 Hz and 5.5 Hz. These 3 frequencies can be inverted individually with the output of one becoming the input of the next.

Alternatively, different domain analysis could be used. For example, time domain analysis could also be used.

Additionally, different types of transforms that could be used with the present invention comprise: directional wavelet transform; a shearlet transform; a curvelet transform.

Further, whilst the present invention has been described with reference to a model which involves solving the acoustic wave equation, the present invention is equally applicable to the models which involve solving the visco-acoustic, elastic, visco-elastic or poro-elastic wave equation.

Further, whilst the example here has used the scalar parameter of pressure as its focus (i.e. P-waves), it is also possible (with appropriate equipment such as geophones) to measure the particle motion in the receiver location and so determine S-wave parameters. Data so-generated could then be utilised and processed in the present invention.

Embodiments of the present invention have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention.

1. A method of subsurface exploration, the method comprising generating a geophysical representation of a portion of the volume of the Earth from measurements of at least one observable physical quantity, and comprising the steps of:
a) providing an observed geophysical data set derived from measurements of at least one observable physical quantity relating to the portion of the volume of the Earth;
b) generating a predicted geophysical data set using a subsurface model of the portion of the Earth, the subsurface model having a spatial geometry and comprising a plurality of model coefficients representing at least one geophysical parameter;
c) providing one or more objective functions operable to measure the similarity and/or dis-similarity between the observed and predicted geophysical datasets;
d) iteratively modifying the subsurface model to minimise and/or maximise the one or more objective functions, wherein the or each iterative step modifies a subsurface model to produce an updated subsurface model and one or more iterative steps comprises:
e) defining one or more directed paths through a subsurface model, the or each directed path being defined with respect to the spatial geometry of the subsurface model;
f) defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and;
g) updating the subsurface model utilising the asymmetric controls; and
h) providing an updated subsurface model of a portion of the Earth for subsurface exploration.

2. A method according to claim 1, wherein the controls comprise constraints and/or penalties on the total amount by which a respective function of the model coefficients and/or updated model coefficients can increase or decrease in the direction of a respective directed path.

3. A method according to claim 1, wherein at least one of the directed paths is substantially vertical.

4. A method according to claim 3, wherein the at least one of the directed paths is in the direction of increasing depth in the subsurface model.

5. A method according to claim 4, wherein the asymmetric controls are configured such that the controls are stronger in the direction of increasing depth in the subsurface model.

6. A method according to claim 4, wherein the model coefficients represent seismic velocity and the controls are configured to reduce or prevent decreases in seismic velocity with increasing depth.

7. A method according to claim 1, wherein one or more controls comprise an asymmetric directional hinge-loss constraint and/or a convex asymmetric directional hinge-loss constraint.

8. (canceled)

9. A method according to claim 7, wherein one or more controls comprise a convex asymmetric directional hinge-loss constraint which is operable to restrict a norm of variations of a function of the model coefficients along the or each respective directed path, such that the sum of the absolute values of a vector of the or each function of the model coefficients is constrained to be less than or equal to a positive value when the respective function is given by a hinge function applied to changes in the said function of the model coefficients along the said directed path such that the said hinge function acts to set either negative or positive changes to zero.

10. A method according to claim 7, wherein the said hinge-loss function comprises a shifted hinge-loss function, wherein the said variations are shifted by a finite amount and set to zero when the shifted entries become either negative or positive.

11. A method according to claim 7, wherein the said hinge-loss function comprises an asymmetric weighted hinge-loss function, wherein the said variations are multiplied by a weighting vector.

12. A method according to claim 11, wherein the said weights and/or shifts are varied between steps of the iteration.

13. A method according to claim 7, wherein the value of the directional hinge-loss constraint is varied between model updates.

14. A method according to claim 9, wherein the said norm is selected from the group of: a one-norm; a p-norm which sums the p^{th} power of the entries followed by taking the p^{th}-root of the sum; a Huber norm, operable to compute the two-norm for the small entries and the one-norm for the lame entries; and a functional derived from statistical distributions.

15. (canceled)

16. (canceled)

17. (canceled)

18. A method according to claim 14, wherein the norm is a functional selected from the group of: a functional derived from the student t distribution; a functional derived from statistical distributions that measure how random variables change together; a functional derived from covariances that measure how random variables change together.

19. (canceled)

20. (canceled)

21. A method according to claim 9, wherein the said variations are replaced by higher-order derivatives.

22. A method according to claim 1, wherein step b) further comprises transforming the said model coefficients by an invertible directional transform.

23. A method according to claim 1, wherein the or each objective function comprises a partial-differential equation constrained optimisation problem.

24. A method according to claim 23, wherein the partial differential equation constrained optimisation problem comprises a convex quadratic approximation to a non-convex objective function.

25. A method according to claim 1, wherein at least one of said objective functions is selected from the group of; a norm misfit objective function; an L₁-norm misfit objective function; and a least-squares misfit objective function.

26. (canceled)

27. (canceled)

28. A method according to claim 1, wherein step g) further comprises minimising the gradient of one or more of the objective functions with respect to said model coefficients.

29. A method according to claim 28, wherein step g) is solved using adjoint-state methods or full-space methods.

30. (canceled)

31. A method according to any one of the preceding claims, where the asymmetric controls are enforced on the Gauss-Newton descend directions of the model coefficients.

32. A method according to any one of the preceding claims, wherein prior geological information is utilised to determine the directed paths and/or the asymmetric controls.

33. (canceled)

34. A method according to claim 2, wherein at least one of the asymmetric controls comprises an asymmetric penalty, and wherein the value of the penalty is variable for each iteration.

35. A method according to claim 34, wherein the value of the penalty is decreased with increasing iterations, or is varied according to a predetermined function or empirical parameter.

36. (canceled)

37. A method according to claim 1, wherein a weighting is applied to the one or more asymmetric controls, the weighting being dependent upon a model parameter.

38. A method according to claim 37, wherein the weighting is dependent upon the spatial location in the subsurface model or spatial geometry of the subsurface model.

39. A method of subsurface exploration, the method comprising generating a geophysical representation of a portion of the volume of the Earth from measurements of at least one observable physical quantity, and comprising the steps of:
a) providing an observed geophysical data set derived from measurements of at least one observable physical quantity relating to the portion of the volume of the Earth;
b) generating a predicted geophysical data set using a subsurface model of the portion of the Earth, the subsurface model having a spatial geometry and comprising a plurality of model coefficients representing at least one geophysical parameter;
c) providing one or more objective functions operable to measure the similarity and/or dis-similarity between the observed and predicted geophysical datasets;
d) iteratively modifying the subsurface model, wherein the or each step of the iteration modifies a subsurface model to produce an updated subsurface model and one or more steps of the iteration comprises:
e) defining one or more directed paths through a subsurface model, the or each directed path being defined with respect to the spatial geometry of the subsurface model;
f) defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and;
g) minimising and/or maximising the one or more controls with respect to the model coefficients of the subsurface model and/or updated subsurface model subject to the constraints upon allowable values of the objective function to produce an updated subsurface model; and
h) providing an updated subsurface model of a portion of the Earth for subsurface exploration.

40. A method according to claim 39, wherein the method further comprises, prior to step g):
i) applying one or more further controls to one or more model parameters, the controls being selected from the group of: bound constraints; bound penalties; total variation constraints; total variation penalties; 11 constraints; 12 constraints; 11 penalties; 12 penalties; higher order total variation penalties; and higher order total variation constraints.

41. A method according to claim 40, wherein the or each further control is varied with each iteration.

42. A method according to claim 1, wherein said at least one geophysical parameter comprises one or more of: pressure wave velocity; shear wave velocity; pressure wave velocity anisotropy; or shear wave velocity anisotropy.

43. A method according to claim 1, wherein said at least one observable physical quantity comprises pressure, particle velocity, particle acceleration or particle displacement.

44. A method according to claim 1, wherein the observed data set and the predicted data set comprise values of a plurality of physical parameters.

45. A method according to claim 1, wherein the observed geophysical data set comprises one or more of: seismic data; electromagnetic data; electrical data; magnetic data; or gravitational data.

46. A method according to claim 1, wherein, subsequent to step h), the method further comprises:
j) utilising the updated subsurface model for subsurface exploration.

47. A non-transitory computer readable storage medium comprising a computer program product executable by a programmed or programmable processing apparatus and comprising one or more software portions for generating a geophysical representation of a portion of the volume of the Earth from measurements of at least one observable physical quantity, and comprising the steps of:
a) providing an observed geophysical data set derived from measurements of at least one observable physical quantity relating to the portion of the volume of the Earth;
b) generating a predicted geophysical data set using a subsurface model of the portion of the Earth, the subsurface model having a spatial geometry and comprising a plurality of model coefficients representing at least one geophysical parameter;
c) providing one or more objective functions operable to measure the similarity and/or dis-similarity between the observed and predicted geophysical datasets;
d) iteratively modifying the subsurface model to minimise and/or maximise the one or more objective functions, wherein the or each iterative step modifies a subsurface model to produce an updated subsurface model and one or more iterative steps comprises:
e) defining one or more directed paths through a subsurface model, the or each directed path being defined with respect to the spatial geometry of the subsurface model;
defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and;
g) updating the subsurface model utilising the asymmetric controls; and
h) providing an updated subsurface model of a portion of the Earth for subsurface exploration.

48. (canceled)

49. A non-transitory computer readable storage medium comprising a computer program product executable by a programmed or programmable processing apparatus and comprising one or more software portions for generating a geophysical representation of a portion of the volume of the Earth from measurements of at least one observable physical quantity, and comprising the steps of:
a) providing an observed geophysical data set derived from measurements of at least one observable physical quantity relating to the portion of the volume of the Earth;
b) generating a predicted geophysical data set using a subsurface model of the portion of the Earth, the subsurface model having a spatial geometry and geophysical parameter;
c) providing one or more Objective functions operable to measure the similarity and/or dis-similarity between the observed and predicted geophysical datasets;
d) iteratively modifying the subsurface model, wherein the or each stet of the iteration modifies a subsurface model to produce an updated subsurface model and one or more steps of the iteration comprises:
e) defining one or more directed paths through a subsurface model, the or each directed path being defined with respect to the spatial geometry of the subsurface model;
f) defining one or more controls on the modifications to the subsurface model, wherein the or each control is operable to control the total amount by which at least one function of the model coefficients of the subsurface model and/or updated subsurface model increases or decreases in the direction of one or more of the directed paths, wherein the defined controls are asymmetric such that, for a given directed path, the controls are different in opposite directions along the given path; and;
g) minimising and/or maximising the one or more controls with respect to the model coefficients of the subsurface model and/or updated subsurface model subject to the constraints upon allowable values of the objective function to produce an updated subsurface model; and
h) providing an updated subsurface model of a portion of the Earth for subsurface exploration.
